(19) United States
(12) Patent Application Publication
(10) Pub. No.: US 2023/0142744 A1
(43) Pub. Date: May 11, 2023

(54) JOINT OPERATION OF SEARCH SPACE SET GROUP SWITCHING AND BANDWIDTH PART SWITCHING

(71) Applicant: QUALCOMM Incorporated, San Diego, CA (US)

(72) Inventors: Wooseok NAM, San Diego, CA (US); Ozcan OZTURK, San Diego, CA (US); Tao LUO, San Diego, CA (US); Yuchul KIM, San Diego, CA (US); Wanshi CHEN, San Diego, CA (US)

(21) Appl. No.: 18/053,741

(22) Filed: Nov. 8, 2022

Related U.S. Application Data
(60) Provisional application No. 63/263,817, filed on Nov. 9, 2021.

(51) Int. Cl. H04W 72/12

(52) U.S. Cl. CPC H04W 72/1278

(57) ABSTRACT

Aspects are provided that allow a user equipment (UE) to facilitate a joint operation of search space set group switching and bandwidth part switching. The UE may switch from a first bandwidth part (BWP) to a second BWP. The UE also may monitor a first search space set group (SSSG) in the second BWP during a scheduled monitoring occasion based on a downlink monitoring configuration.

### CROSS REFERENCE TO RELATED APPLICATION(S)

This application claims the benefit of and priority to U.S. Provisional Application Ser. No. 63/263,817, entitled “JOINT OPERATION OF SEARCH SPACE SET GROUP SWITCHING AND BANDWIDTH PART SWITCHING” and filed on Nov. 9, 2021, which is expressly incorporated by reference herein in its entirety.

### BACKGROUND

### Technical Field

The present disclosure generally relates to communication systems, and more particularly, to a joint operation of search space set group switching and bandwidth part switching.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a user equipment (UE). The UE switches from a first bandwidth part (BWP) to a second BWP. The UE also monitors a first search space set group (SSSG) in the second BWP during a scheduled monitoring occasion based on a downlink monitoring configuration.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a call flow diagram between a UE and a base station.

FIG. 5 is a flowchart of a method of wireless communication at a UE.

FIG. 6 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

In an unlicensed band operation, a base station may only start transmitting control and data after acquiring a channel (e.g., via a listen-before-talk (LBT) procedure) and when UEs are monitoring control. To have more frequent channel access opportunities (instead of waiting for a next slot boundary to start transmitting and risk losing the communication medium), the base station can configure a UE to perform mini-slot-based control monitoring. Within a channel occupancy time (COT), there may be no need for a UE to continue monitoring at a mini-slot level. To support this use case, a dynamic physical downlink control channel (PDCCH) monitoring switching mechanism is provided in 5G NR systems. A UE can be provided with two groups of search space sets and switch between the two groups of search space sets. For example, one search space set group can be provided for out-of-COT and the other search space set group can be provided for inside-of-COT. In some examples, the PDCCH monitoring switching mechanism can be explicit via downlink control information (DCI) signaling (e.g., bit location in a DCI with format DCI 2_0) or implicit (e.g., by PDCCH decoding) with the assistance of COT duration information and an automatic fallback timer.

In more recent 5G NR systems, SSSG switching can be supported for licensed frequency band operation for UE power saving. For example, the SSSG switching can include switching between a first search space set group (e.g., Group 0) and a second search space set group (e.g., Group 1). In some aspects, the Group 0 may correspond to a default search space set group, in which the UE can perform sparse PDCCH monitoring for power savings. In some aspects, the UE can perform more frequent PDCCH monitoring under Group 1 for performance (e.g., high throughput, low latency, etc.).

In some approaches for UE-based power savings, the PDCCH monitoring switching mechanism can include two functions, PDCCH skipping and SSSG switching, which are supported for PDCCH monitoring adaptation. A scheduling DCI (e.g., format 0_1/0_2/1_1/1_2) can indicate the PDCCH monitoring adaptation along with physical downlink shared channel (PDSCH)/physical uplink shared channel (PUSCH) scheduling. The scheduling DCI may include up to a two-bit field for the indication based on the following use cases. In a first use case, the scheduling DCI indicates a PDCCH skipping function, where each codepoint may be mapped to a respective PDCCH skip duration. In a second use case, the scheduling DCI indicates two SSSG switching functions, where each codepoint (e.g., 0 and 1) may be mapped to a respective SSSG index. In a third use case, the scheduling DCI indicates three SSSG switching functions, where each codepoint (e.g., 0, 1, and 2) may be mapped to a respective SSSG index. In a fourth use case, the scheduling DCI indicates two SSSG switching functions along with a PDCCH skipping function, where each codepoint may be mapped to PDCCH skipping for a certain duration or a SSSG index. In some aspects, the configuration of the PDCCH monitoring adaptation may be per bandwidth part (BWP). The size of the DCI indication field may vary between 0 and 2 bits for each BWP.

Generally, a BWP is a contiguous set of physical resource blocks (PRBs) for a given numerology on a given carrier. BWPs facilitate power-efficient communication between a base station and a UE on the given carrier or band. For instance, a base station may assign resources specifically within an active BWP for a UE (as opposed to broadly within PRBs of the entire band), and the UE may search for data or signaling from the base station in the active BWP rather than within PRBs of the entire band.

A base station and UE may switch BWPs. For example, the UE may switch from a source BWP to a target BWP. Switching BWPs involves activating a configured (de-activated) BWP and de-activating an active BWP. When switching BWPs, the base station and UE may switch between DL BWPs and between UL BWPs simultaneously in time division duplex (TDD) deployments and independently in frequency division duplex (FDD) deployments. Moreover, in TDD deployments, the base station may provide a common or dedicated slot format configuration to the UE indicating which symbols of a slot are downlink or uplink, and the activated DL BWP or UL BWP may be applied in DL or UL symbols accordingly.

The scheduling DCI may contain both a BWP indicator field (e.g., up to 2 bits) and a SSSG indicator field. The DCI can indicate a target BWP that the UE should switch to, as well as the SSSG that the UE should monitor in the target BWP.

In some cases, the DCI may indicate to the UE to switch between BWPs either without a SSSG indicator or with an incomplete SSSG indicator. In a first use case, the BWP switching may be triggered by the DCI without a SSSG indicator field. For example, a source BWP may not be configured with SSSG switching (i.e., zero-bit SSSG indicator field in the scheduling DCI), while the target BWP is configured with SSSG switching (i.e., one or two-bit SSSG indicator field). Alternatively, the source BWP may have a one-bit SSSG indicator field, while the target BWP has a two-bit SSSG indicator field. Further alternatively, the source BWP may be configured with PDCCH skipping (without SSSG switching), while the target BWP is configured with SSSG switching. In each of these aforementioned examples, the BWP switching may occur without indication to the UE to perform SSSG switching. In a second use case, the BWP switching is triggered by radio resource control (RRC) configuration. In this regard, the RRC configuration does not include any indication to the UE to perform SSSG switching. In a third use case, the BWP switching is triggered by the expiration of a BWP inactivity timer. In this regard, the expiration of the BWP inactivity timer would occur independent of any indication to the UE to perform SSSG switching. In the aforementioned use cases, the UE behavior of monitoring a SSSG in the target BWP may not be determined.

The present disclosure provides for a joint operation of search space set group switching and bandwidth part switching, where the UE behavior of monitoring a SSSG in a target BWP can still be determined when the UE switches BWPs. For example, the UE can switch from a first BWP to a second BWP, and monitor a SSSG in the second BWP during a scheduled monitoring occasion based on a downlink monitoring configuration. The first BWP and second BWP may be associated with a licensed frequency band in some implementations, or associated with an unlicensed frequency band in other implementations. The downlink monitoring adaptation configuration can configure the UE to determine the SSSG when the SSSG switching indication is not present or incomplete.

As used herein, a set of PDCCH candidates for a UE to monitor may be defined in terms of PDCCH search space sets. In some aspects, a search space may be defined as a frequency and time location where the UE has to search for its PDCCH. The PDCCH may be mapped to a specific search space set according to information indicative of a SSSG (e.g., DCI). In some aspects, the number of resource blocks and the number of symbols available for a search space set may be defined by a control resource set (CORESET).

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure.

One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

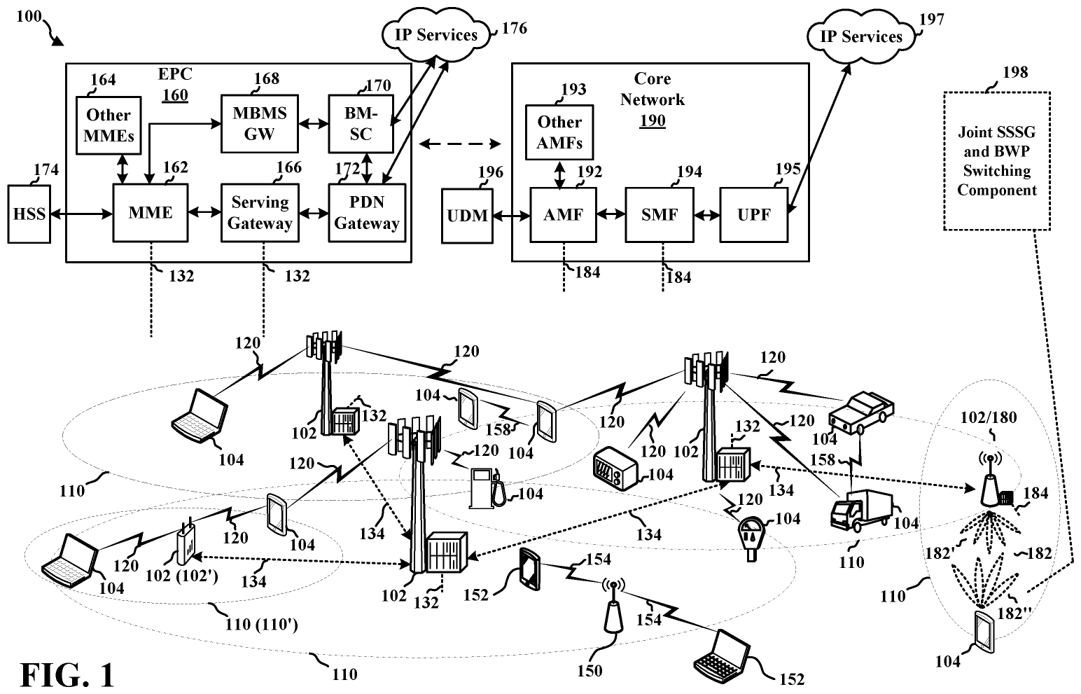

FIG. 1 is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNB s) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

Referring again to FIG. 1, in certain aspects, the UE 104 may include a joint SSSG and BWP switching component 198 that is configured to switch from a first bandwidth part (BWP) to a second BWP. The joint SSSG and BWP switching component 198 may also be configured to monitor a first search space set group (SSSG) in the second BWP during a scheduled monitoring occasion based on a downlink monitoring configuration.

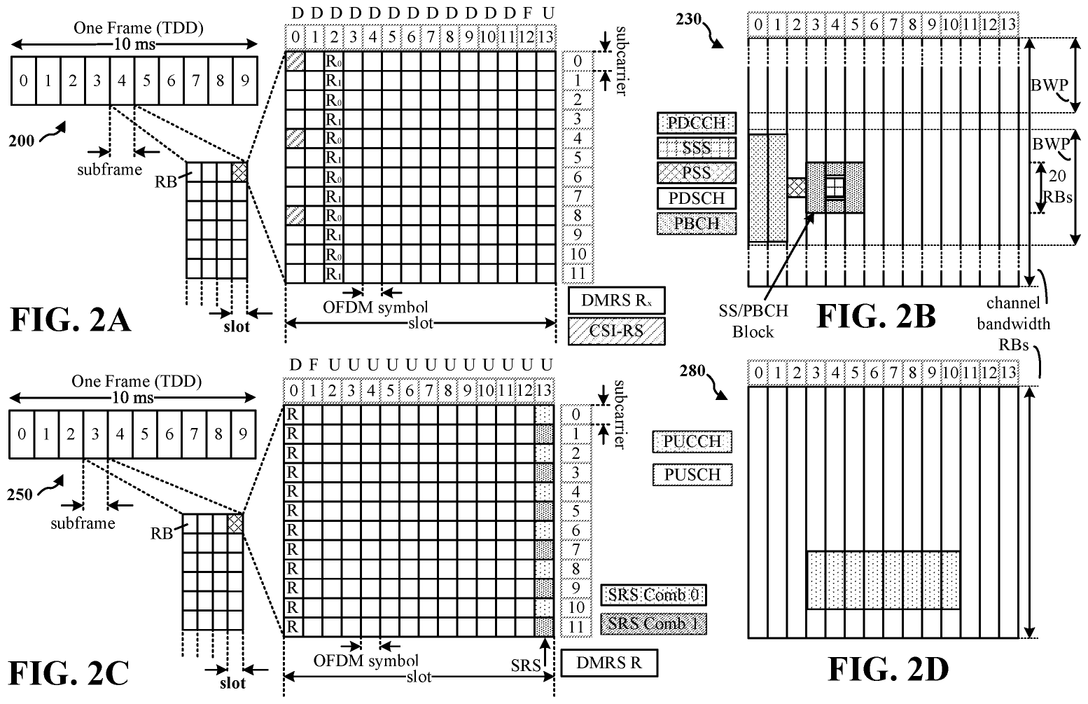

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a CORESET. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

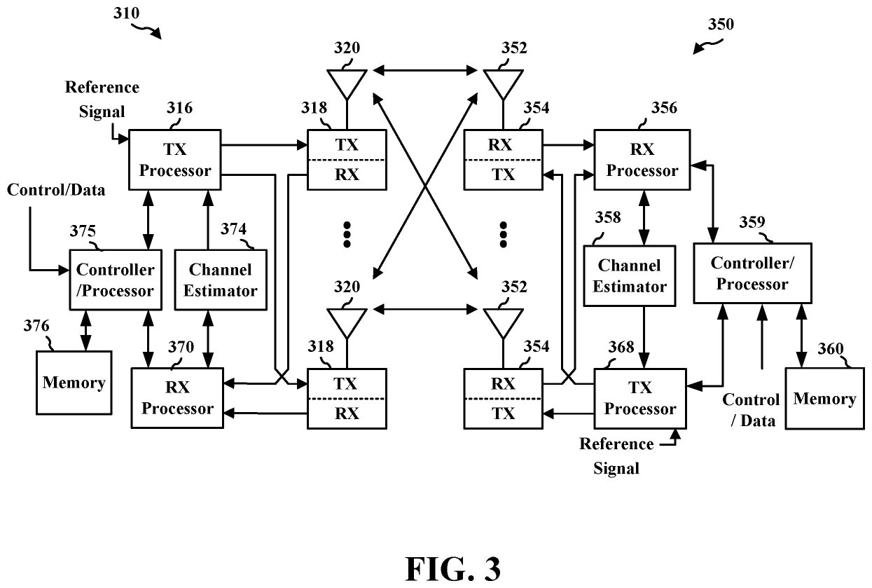

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with a joint SSSG and BWP switching of FIG. 1.

In an unlicensed band operation, a base station may only start transmitting control and data after acquiring a channel (e.g., via a listen-before-talk (LBT) procedure) and when UEs are monitoring control. To have more frequent channel access opportunities (instead of waiting for a next slot boundary to start transmitting and risk losing the communication medium), the base station can configure a UE to perform mini-slot-based control monitoring. Within a COT, there may be no need for a UE to continue monitoring at a mini-slot level. To support this use case, a dynamic downlink (e.g., PDCCH) monitoring switching mechanism is provided in 5G NR systems. A UE can be provided with two groups of search space sets and switch between the two groups of search space sets. For example, one search space set group can be provided for out-of-COT and the other search space set group can be provided for inside-of-COT. In some examples, the PDCCH monitoring switching mechanism can be explicit via DCI signaling (e.g., bit location in a DCI with format DCI 2_0) or implicit (e.g., by PDCCH decoding) with the assistance of COT duration information and an automatic fallback timer.

In more recent 5G NR systems, SSSG switching can be supported for licensed frequency band operation for UE power saving. For example, the SSSG switching can include switching between a first search space set group (e.g., Group 0) and a second search space set group (e.g., Group 1). In some aspects, the Group 0 may correspond to a default search space set group, in which the UE can perform sparse PDCCH monitoring for power savings. In some aspects, the UE can perform more frequent PDCCH monitoring under Group 1 for performance (e.g., high throughput, low latency, etc.).

In some approaches for UE-based power savings, the downlink monitoring switching mechanism can include two functions, PDCCH skipping and SSSG switching, which are supported for PDCCH monitoring adaptation. A scheduling DCI (e.g., format 0_1/0_2/1_1/1_2) can indicate the PDCCH monitoring adaptation along with PDSCH/PUSCH scheduling. The scheduling DCI may include up to a two-bit field for the indication based on the following use cases. In a first use case, the scheduling DCI indicates a PDCCH skipping function, where each codepoint may be mapped to a respective PDCCH skip duration. In a second use case, the scheduling DCI indicates two SSSG switching functions, where each codepoint (e.g., 0 and 1) may be mapped to a respective SSSG index. In a third use case, the scheduling DCI indicates three SSSG switching functions, where each codepoint (e.g., 0, 1, and 2) may be mapped to a respective SSSG index. In a fourth use case, the scheduling DCI indicates two SSSG switching functions along with a PDCCH skipping function, where each codepoint may be mapped to PDCCH skipping for a certain duration or a SSSG index. In some aspects, the configuration of the PDCCH monitoring adaptation may be per bandwidth part (BWP). The size of the DCI indication field may vary between 0 and 2 bits for each BWP.

The scheduling DCI may contain both a BWP indicator field (e.g., up to 2 bits) and a SSSG indicator field. The DCI can indicate a target BWP that the UE should switch to, as well as the SSSG that the UE should monitor in the target BWP.

In some cases, the DCI may indicate to the UE to switch between BWPs either without a SSSG indicator or with an incomplete SSSG indicator. In a first use case, the BWP switching may be triggered by the DCI without a SSSG indicator field. For example, a source BWP may not be configured with SSSG switching (i.e., zero-bit SSSG indicator field in the scheduling DCI), while the target BWP is configured with SSSG switching (i.e., one or two-bit SSSG indicator field). Alternatively, the source BWP may have a one-bit SSSG indicator field, while the target BWP has a two-bit SSSG indicator field. Further alternatively, the source BWP may be configured with PDCCH skipping (without SSSG switching), while the target BWP is configured with SSSG switching. In each of these aforementioned examples, the BWP switching may occur without indication to the UE to perform SSSG switching. In a second use case, the BWP switching is triggered by radio resource control (RRC) configuration. In this regard, the RRC configuration does not include any indication to the UE to perform SSSG switching. In a third use case, the BWP switching is triggered by the expiration of a BWP inactivity timer. In this regard, the expiration of the BWP inactivity timer would occur independent of any indication to the UE to perform SSSG switching. In the aforementioned use cases, the UE behavior of monitoring a SSSG in the target BWP may not be completely determined.

The present disclosure provides for a joint operation of search space set group switching and bandwidth part switching, where the UE behavior of monitoring a SSSG in a target BWP can still be determined when the UE switches BWPs. For example, the UE can switch from a first BWP to a second BWP, and monitor a SSSG in the second BWP during a scheduled monitoring occasion based on a downlink monitoring configuration. The downlink monitoring configuration can configure the UE to determine the SSSG when the SSSG switching indication is not present or incomplete.

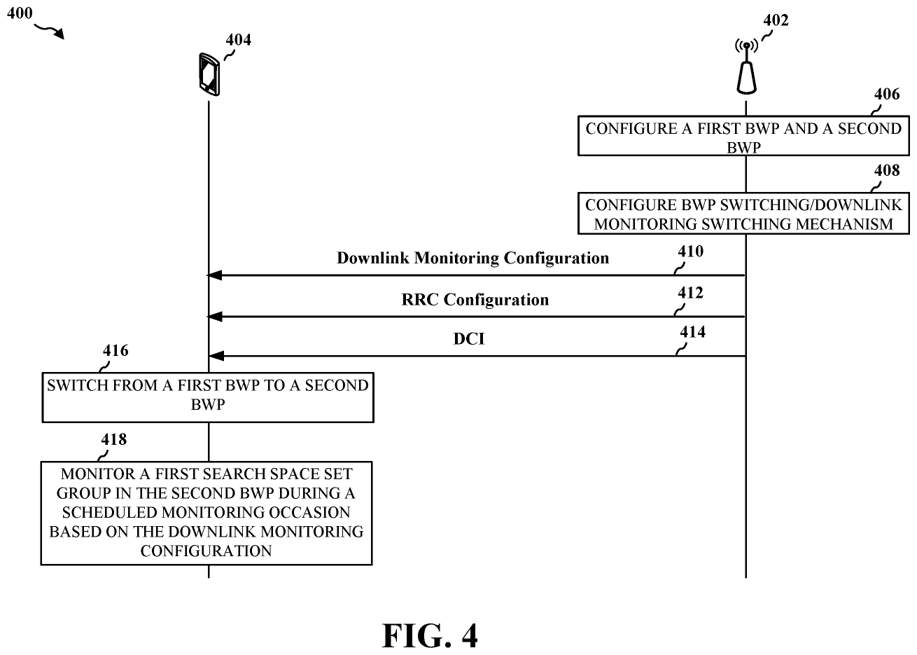

FIG. 4 is an example 400 of a call flow between a UE 404 and a base station 402. Initially, at 406, the base station may configure a first BWP and a second BWP. The first BWP and second BWP may be associated with a licensed frequency band in some implementations, or associated with an unlicensed frequency band in other implementations. In some aspects, a BWP is a contiguous set of PRBs for a given numerology on a given carrier. BWPs facilitate power-efficient communication between the base station 402 and the UE 404 on the given carrier or band. For instance, the base station 402 may assign resources specifically within an active BWP for the UE 404 (as opposed to broadly within PRBs of the entire band), and the UE 404 may search for data or signaling from the base station 402 in the active BWP rather than within PRBs of the entire band.

At 408, the base station 402 may configure BWP switching and/or downlink monitoring switching mechanism. The base station 402 and the UE 404 may switch BWPs. Switching BWPs involves activating a configured (de-activated) BWP and de-activating an active BWP. In some cases, the DCI 414 may indicate to the UE 404 to switch between BWPs either without a SSSG indicator or with an incomplete SSSG indicator. In a first use case, the BWP switching may be triggered by the DCI 414 without a SSSG indicator field. For example, a source BWP may not be configured with SSSG switching, while the target BWP is configured with SSSG switching. For purposes of explanation, the source BWP may refer to a first BWP (or BWP1) and the target BWP may refer to a second BWP (or BWP2). Alternatively, the source BWP may have a one-bit SSSG indicator field in the DCI 414, while the target BWP has a two-bit SSSG indicator field in the DCI 414. Further alternatively, the source BWP may be configured with PDCCH skipping (without SSSG switching), while the target BWP is configured with SSSG switching. In each of these aforementioned examples, the BWP switching may occur without indication to the UE 404 to perform SSSG switching.

In some aspects, the BWP switching is based on the expiration of a BWP inactivity timer. For example, the base station 402 and the UE 404 may switch to an active BWP, namely, a configured default downlink BWP, in response to expiration of a configured BWP inactivity timer. For instance, if the RRC configuration 412 indicates a configured DL BWP as the default downlink BWP, and if the DCI 414 indicating a downlink assignment or uplink grant is not received at the UE 404 within the time indicated by the BWP inactivity timer, the base station 402 and UE 404 may switch to the default DL BWP. In this regard, the expiration of the BWP inactivity timer may occur independent of any indication to the UE 404 to perform SSSG switching.

In other aspects, the medium access control (MAC) element of the UE 404 may itself switch to an active BWP upon initiation of a random access procedure.

The base station 402 may provide a downlink monitoring configuration 410 to the UE 404, which includes a configuration for the downlink monitoring switching mechanism. The downlink monitoring switching mechanism can include two functions, PDCCH skipping and SSSG switching, which are supported for PDCCH monitoring adaptation. SSSG switching can be supported for licensed frequency band operation for UE power saving. For example, the SSSG switching can include switching between a first search space set group (e.g., Group 0) and a second search space set group (e.g., Group 1). In some aspects, the Group 0 may correspond to a default search space set group, in which the UE can perform sparse PDCCH monitoring for power savings. In some aspects, the UE can perform more frequent PDCCH monitoring under Group 1 for performance (e.g., high throughput, low latency, etc.). In other implementations, the SSSG switching also may be supported for unlicensed frequency band operation.

In some aspects, the base station and UE may switch to an active BWP in response to RRC signaling. For example, the BWP switching is based on a RRC configuration 412. In some aspects, the BWP switching may be performed in response to the RRC configuration 412, or may be triggered by the RRC configuration 412. In some aspects, the base station 402 may provide the RRC configuration 412 to the UE 404, which may be included within the downlink monitoring configuration 410 or separate from the downlink monitoring configuration 410. For instance, if the RRC configuration 412 indicates a configured DL BWP as a first active DL BWP or a configured UL BWP as a first active UL BWP, then upon reconfiguration or activation of a serving cell, the base station 402 and the UE 404 may switch to the indicated first active DL BWP or the indicated first active UL BWP. For instance, the base station 402 may provide the RRC configuration 412 (e.g., a table) to the UE 404 that includes associations of active BWPs, next active BWPs, and/or associated SSSG switching configurations, and the base station 402 and the UE 404 may apply the RRC configuration 412 in response to expiration of a BWP inactivity timer or in response to missing information in DCI or an indication in DCI (or an RRC reconfiguration) to refer to the RRC configuration 412. In some aspects, the RRC configuration 412 may not include any indication to the UE 404 to perform SSSG switching.

The RRC configuration 412 may configure uplink and downlink BWPs with various parameters. These RRC parameters may include, for example, a BWP identifier or index for each BWP, a location and number of contiguous PRBs in frequency for each BWP, a subcarrier spacing for each BWP, and a cyclic prefix for each BWP. Moreover, the RRC configuration may indicate an initial downlink BWP for initial downlink transmissions (e.g., a control resource set (CORESET) #0), an initial uplink BWP for initial uplink transmissions (e.g., following reconfiguration or activation of a cell), the BWP inactivity timer (e.g., a timer which may increment by 0.5 or 1 ms depending on frequency range each period that a DCI is not received), a default downlink BWP (e.g., a DL BWP to which the base station and UE may switch in response to expiration of the BWP inactivity timer), a first active downlink BWP for downlink transmissions (e.g., following reconfiguration or activation of a cell), and a first active uplink BWP for uplink transmission (e.g., following reconfiguration or activation of a cell). Generally, a base station may configure up to four DL BWPs and up to four UL BWPs for a UE, of which only 1 BWP may be active in a UL or DL direction at a given time.

The base station 402 may further provide a DCI 414 to the UE 404. The DCI 414 may indicate BWP switching in addition to downlink or uplink assignments or grants. The DCI 414 may include a BWP indicator field indicating a BWP index, and the UE 404 may switch to an active BWP corresponding to the indicated BWP index in response to the DCI 414. The DCI 414 may be for a downlink assignment or an uplink grant. For instance, the base station 402 may configure the DCI 414 to indicate a BWP index corresponding to a configured UL BWP or DL BWP, and if the indicated BWP index is different than that of a current active BWP, the UE 404 may switch to the corresponding UL or DL BWP. For instance, the base station 402 may provide the DCI 414 (including BWP indicator field(s) and SSSG indicator field(s)) to the UE 404 indicating to the UE 404 to switch from BWP1 to BWP2).

The DCI 414 may be a scheduling DCI (e.g., format 0_1/0_2/1_1/1_2) that indicates the PDCCH monitoring adaptation along with physical downlink shared channel (PDSCH)/PUSCH scheduling. The DCI 414 may include up to a two-bit field for the indication based on the following use cases. In a first use case, the DCI 414 may indicate a PDCCH skipping function, where each codepoint may be mapped to a respective PDCCH skip duration. In a second use case, the DCI 414 may indicate two SSSG switching functions, where each codepoint (e.g., 0 and 1) may be mapped to a respective SSSG index. In a third use case, the DCI 414 may indicate three SSSG switching functions, where each codepoint (e.g., 0, 1, and 2) may be mapped to a respective SSSG index. In a fourth use case, the DCI 414 may indicate two SSSG switching functions along with a PDCCH skipping function, where each codepoint may be mapped to PDCCH skipping for a certain duration or a SSSG index.

In some aspects, the configuration of the PDCCH monitoring adaptation may be per BWP. The size of the DCI indication field may vary between 0 and 2 bits for each BWP. The DCI 414 may contain both the BWP indicator field (e.g., up to 2 bits) and a SSSG indicator field. The DCI 414 can indicate a target BWP that the UE 404 should switch to, as well as the SSSG that the UE 404 should monitor in the target BWP.

In an additional example, if BWP2 is the current active BWP, then in response to expiration of the BWP inactivity timer, missing information in the DCI 414, or some other indication (e.g., in the DCI 414), the UE 404 may determine from (e.g., based on) the RRC configuration 412 to switch from BWP1 to BWP2.

At 416, the UE 404 may switch from a first BWP to a second BWP. As an example, while BWP1 is active, the base station may provide DCI 414 or an RRC reconfiguration (e.g., configuration 410 or a different configuration) to the UE 404 indicating to the UE 404 to switch from BWP1 to BWP2. For example, if the base station 402 indicates in the DCI 414 or the RRC configuration 412 to transition into BWP2, the UE 404 switches BWPs in response to the DCI 414 or following reconfiguration or activation of a cell.

At 418, the UE 404 may monitor a first SSSG in the second BWP during a scheduled monitoring occasion based on the downlink monitoring configuration.

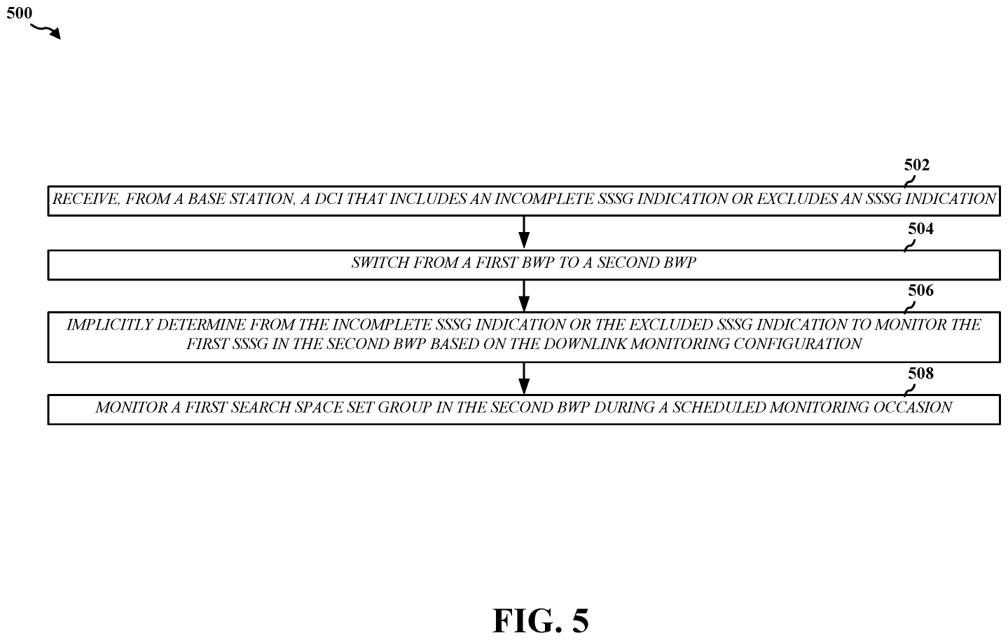

FIG. 5 is a flowchart 500 of a method of wireless communication. The method may be performed by a UE (e.g., the UE 104, 404; the apparatus 602). As illustrated, the flowchart 500 includes a number of enumerated steps, but embodiments of the flowchart 500 may include additional steps before, after, and in between the enumerated steps. In some embodiments, one or more of the enumerated steps may be omitted or performed in a different order. Optional aspects are illustrated with a dashed line.

At 502, the UE may receive a DCI from a base station, where the DCI indicates the second BWP for the switching (at 504), and the DCI further indicates information indicative of whether to perform the SSSG switching. For example, 502 may be performed by DCI component 644. In one example, the first slot format may be switched to the second slot format in response to the DCI. For instance, referring to FIG. 4, the UE 404 may receive DCI 414 from the base station 402 indicating (e.g., in a BWP indicator field) to the UE to switch to a second BWP identified as the target BWP and further indicating (e.g., in a SSSG indicator field) to the UE to monitor a first SSSG in the second BWP.

In some aspects, the information indicative of whether to perform the SSSG switching is interpreted according to the SSSG switching configuration associated with the second BWP based on the switching from the first BWP to the second BWP being performed based on a DCI that is indicative of whether to perform BWP switching. In some aspects, the information indicative of whether to perform the SSSG switching is included in a same DCI message as the information indicative of whether to perform the BWP switching.

In some aspects, the downlink monitoring configuration indicates that the first BWP is associated with a first SSSG switching configuration indicating a first number of search space set groups and the second BWP is associated with a second SSSG switching configuration indicating a second number of search space set groups greater than the first number of search space set groups. In some aspects, the DCI indicates a portion of the second number of search space set groups that corresponds up to the first number of search space set groups based on the second number of search space set groups being greater than the first number of search space set groups. For example, the first BWP may be configured with two SSSGs respectively associated with a first SSSG index value and a second SSSG index value, and the second BWP is configured with three SSSGs respectively associated with the first SSSG index value, the second SSSG index value, and a third SSSG index value. In some aspects, the DCI includes only one of the first SSSG index value or the second SSSG index value.

In some aspects, the downlink monitoring configuration indicates that the first BWP is associated with a first SSSG switching configuration indicating a first number of search space set groups and the second BWP is associated with a second SSSG switching configuration indicating a second number of search space set groups smaller than the first number of search space set groups. In some aspects, the DCI indicates each of the second number of search space set groups based on the second number of search space set groups being smaller than the first number of search space set groups. For example, the second BWP may be configured with two SSSGs respectively associated with a first SSSG index value and a second SSSG index value, wherein the first BWP is configured with three SSSGs respectively associated with the first SSSG index value, the second SSSG index value, and a third SSSG index value. The DCI may include only one of the first SSSG index value or the second SSSG index value.

In some aspects, the downlink monitoring configuration indicates that the first BWP is associated with a PDCCH skipping configuration and the second BWP is associated with the SSSG switching configuration. In some aspects, the DCI comprises information indicative of whether to perform PDCCH skipping that is interpreted as the information indicative of whether to perform the SSSG switching. For example, the DCI includes a first field including information and a second field including information, and the first BWP is configured with PDCCH skipping and the second BWP is configured with SSSG switching. In some implementations, the UE may interpret the first field as the second field.

At 504, the UE switches from a first BWP to a second BWP. For example, 504 may be performed by switch component 642. For instance, referring to FIG. 4, the UE 404 may switch from the first BWP to the second BWP. In some aspects, the switching from the first BWP to the second BWP is based on information indicative of whether to perform BWP switching. For example, the information indicative of whether to perform BWP switching may include a first DCI without information indicative of the SSSG; a second DCI with incomplete information indicative of the SSSG; RRC configuration information; expiration of a BWP inactivity timer; or expiration of an SSSG timer. In some aspects, the switching to the second BWP is performed with information indicative of whether to perform SSSG switching in the second BWP.

At 506, the UE may implicitly determine from (e.g., based on) the incomplete SSSG indication or the excluded SSSG indication to monitor a first SSSG in the second BWP based on the downlink monitoring configuration. For example, 506 may be performed by determination component 646. In some aspects, the downlink monitoring configuration includes a SSSG switching configuration for a plurality of search space set groups in the second BWP when the information is indicative of performing the SSSG switching.

In one or more implementations, the downlink monitoring configuration may provide a configuration for UE behavior of monitoring a SSSG in a new BWP (or target BWP). For example, the downlink monitoring configuration may provide a designation of a first SSSG in the new BWP. In another example, the downlink monitoring configuration may maintain a previous SSSG index.

In a BWP, which may be configured with SSSG switching, one of the configured SSSGs can be designated as a “first SSSG.” As such, the SSSG switching configuration indicates whether one of the plurality of search space set groups is designated as the first SSSG.

In some aspects, the SSSG switching configuration includes a default SSSG. The first SSSG may correspond to the default SSSG based on the SSSG switching configuration not indicating that at least one of the plurality of search space groups is designated as the first SSSG. For example, if the first SSSG is not configured, the default SSSG may be assumed to be the first SSSG.

In some aspects, the first SSSG may correspond to a previous SSSG index that the UE monitored in the second BWP in a previous downlink monitoring occasion. For example, the “previous SSSG index” can be the SSSG index that the UE has monitored in the same target BWP in the past (e.g., the latest time that the UE was in the same BWP).

In other aspects, the first SSSG corresponds to a previous SSSG index that the UE monitored in the first BWP in a previous downlink monitoring occasion based on each of the first BWP and the second BWP being associated with information indicative of performing SSSG switching respectively in the first BWP and the second BWP. For example, the “previous SSSG index” can be the SSSG index that the UE has monitored in the source BWP in the past if both the source BWP and target BWP are configured with SSSGs.

In one or more implementations, the SSSG switching may be performed based on a SSSG timer. In some aspects, the SSSG timer and the BWP inactivity timer may operate independently of one another. In some aspects, the first SSSG is associated with the SSSG timer and the first BWP or the second BWP is associated with the BWP inactivity timer. For example, the BWP inactivity timer and the SSSG timer can run independently and do not affect each other. In other aspects, the SSSG timer is dependent on the BWP inactivity timer. In one or more aspects, the UE may terminate or suspend the SSSG timer after switching from the first BWP to the second BWP. For example, if the BWP switching is performed either by DCI indication or expiration of the BWP inactivity timer, the SSSG timer, if running, may either be terminated or suspended. In some aspects, the SSSG timer may be suspended or terminated in response to the switching from the first BWP to the second BWP. After switching to the first BWP from the second BWP, the UE may start the suspended or terminated SSSG timer. In one aspects, the UE may resume the SSSG timer from where it left off at the time it was suspended.

At 508, the UE may monitor the first SSSG in the second BWP during a scheduled monitoring occasion. For example, 508 may be performed by monitor component 650. In some aspects, the UE may monitor a downlink channel in the second BWP according to the first SSSG based on the switching from the first BWP to the second BWP being performed without the information indicative of performing the SSSG switching. For example, if the UE switches BWP without SSSG indication (e.g., incomplete SSSG indication or excluded SSSG indication), the UE can monitor PDCCH in the second BWP according to the first SSSG before the UE receives another SSSG indication in the second BWP.

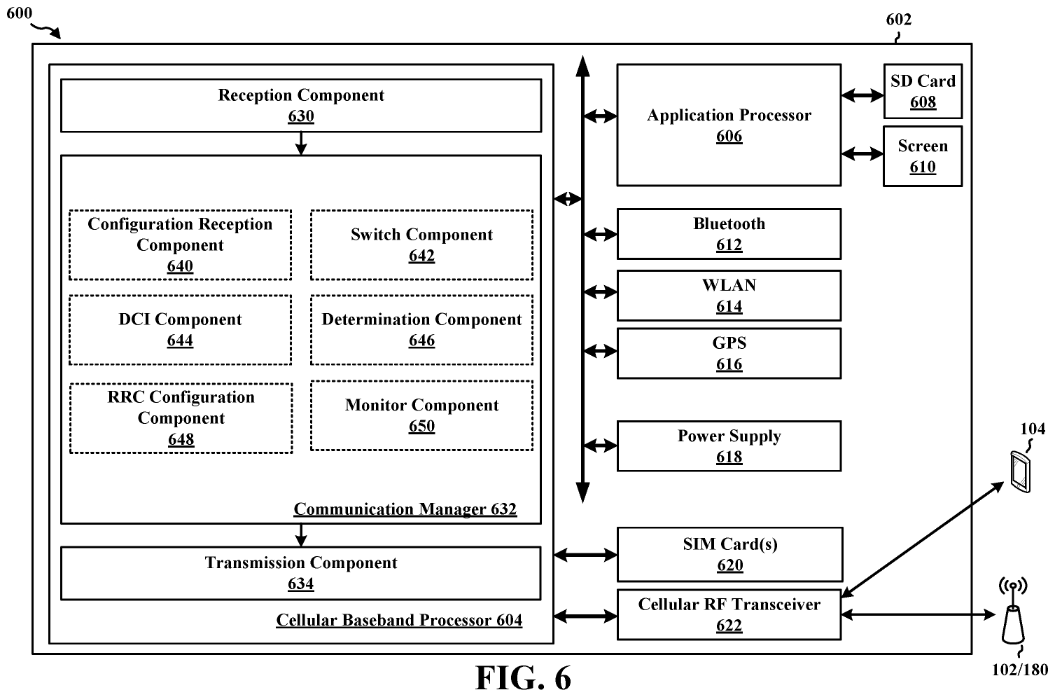

FIG. 6 is a diagram 600 illustrating an example of a hardware implementation for an apparatus 602. The apparatus 602 is a UE and includes a cellular baseband processor 604 (also referred to as a modem) coupled to a cellular RF transceiver 622 and one or more subscriber identity modules (SIM) cards 620, an application processor 606 coupled to a secure digital (SD) card 608 and a screen 610, a Bluetooth module 612, a wireless local area network (WLAN) module 614, a Global Positioning System (GPS) module 616, and a power supply 618. The cellular baseband processor 604 communicates through the cellular RF transceiver 622 with the UE 104 and/or BS 102/180. The cellular baseband processor 604 may include a computer-readable medium/memory. The computer-readable medium/memory may be non-transitory.

The cellular baseband processor 604 is responsible for general processing, including the execution of software stored on the computer-readable medium/memory. The software, when executed by the cellular baseband processor 604, causes the cellular baseband processor 604 to perform the various functions described supra. The computer-readable medium/memory may also be used for storing data that is manipulated by the cellular baseband processor 604 when executing software. The cellular baseband processor 604 further includes a reception component 630, a communication manager 632, and a transmission component 634. The communication manager 632 includes the one or more illustrated components. The components within the communication manager 632 may be stored in the computer-readable medium/memory and/or configured as hardware within the cellular baseband processor 604. The cellular baseband processor 604 may be a component of the UE 350 and may include the memory 360 and/or at least one of the TX processor 368, the RX processor 356, and the controller/processor 359. In one configuration, the apparatus 602 may be a modem chip and include just the baseband processor 604, and in another configuration, the apparatus 602 may be the entire UE (e.g., see 350 of FIG. 3) and include the aforediscussed additional modules of the apparatus 602.

The communication manager 632 includes a configuration reception component 640 that is configured to receive, from a base station, a BWP configuration indicating a configuration of a first BWP and a second BWP. The configuration reception component 640 also may receive, from the base station, a configuration of the BWP switching and a configuration of the downlink monitoring switching mechanism. The communication manager 632 further includes a switch component 642 that receives input in the form of the first BWP and the second BWP from the configuration reception component 640 and is configured to switch from the first BWP to the second BWP, e.g., as described in connection with 504. The communication manager 632 further includes a DCI component 644 that is configured to receive a DCI from the base station, where the DCI indicates the second BWP for the switching, and the DCI further indicates information indicative of whether to perform SSSG switching, where the DCI may include an incomplete SSSG indication or excludes the SSSG indication, e.g., as described in connection with 502. The communication manager 632 further includes a determination component 646 that receives input in the form of the downlink monitoring switching configuration from the configuration reception component 640 or the DCI from the DCI component 644 and is configured to implicitly determine from either the incomplete SSSG indication or the excluded SSSG indication to monitor the first SSSG in the second BWP based on the downlink monitoring configuration, e.g., as described in connection with 506. The communication manager 632 further includes a RRC configuration component 648 that is configured to receive a RRC configuration, where the RRC configuration may be used to trigger BWP switching at the UE. The communication manager 632 further includes a monitor component 650 that is configured to monitor the first SSSG in the second BWP during a scheduling monitoring occasion, where the first SSSG is among one of a plurality of SSSGs, e.g., as described in connection with 508.

The apparatus may include additional components that perform each of the blocks of the algorithm in the aforementioned flowchart of FIG. 5. As such, each block in the aforementioned flowchart of FIG. 5 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 602, and in particular the cellular baseband processor 604, includes means for switching from a first bandwidth part (BWP) to a second BWP. The apparatus 602, and in particular the cellular baseband processor 604, also includes means for monitoring a first search space set group (SSSG) in the second BWP during a scheduled monitoring occasion based on a downlink monitoring configuration.

The aforementioned means may be one or more of the aforementioned components of the apparatus 602 configured to perform the functions recited by the aforementioned means. As described supra, the apparatus 602 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

The following examples are illustrative only and may be combined with aspects of other embodiments or teachings described herein, without limitation.

Aspect 1 is a method of wireless communication performed by a network node, such as a user equipment (UE) that includes switching from a first bandwidth part (BWP) to a second BWP; and monitoring a first search space set group (SSSG) in the second BWP during a scheduled monitoring occasion based on a downlink monitoring configuration.

In Aspect 2, the method of Aspect 1 further includes that the downlink monitoring configuration indicates one SSSG of a plurality of SSSGs configured for the second BWP as the first SSSG.

In Aspect 3, the method of Aspect 1 or Aspect 2 further includes that the first SSSG corresponds to a default SSSG based on the downlink monitoring configuration excluding information indicative that at least one of a plurality of SSSGs is the first SSSG.

In Aspect 4, the method of Aspect 2 further includes that the monitoring the first SSSG is performed before receiving or without receiving an SSSG indication indicative of the first SSSG, and wherein the first SSSG corresponds to a default SSSG.

In Aspect 5, the method of Aspect 2 further includes that the monitoring the first SSSG comprises monitoring a downlink channel in the second BWP according to the first SSSG based on switching from the first BWP to the second BWP being performed before receiving or without receiving an SSSG indication associated with the second BWP.

In Aspect 6, the method of Aspect 2 further includes that the switching to the second BWP is performed with information indicative of whether to perform SSSG switching in the second BWP, wherein the downlink monitoring configuration includes a SSSG switching configuration for the plurality of SSSGs in the second BWP when the information is indicative of performing the SSSG switching, wherein the information indicative of whether to perform the SSSG switching is interpreted according to the SSSG switching configuration associated with the second BWP based on the switching from the first BWP to the second BWP being performed based on a downlink control information (DCI) that is indicative of whether to perform BWP switching, wherein the information indicative of whether to perform the SSSG switching is included in a same DCI message as the information indicative of whether to perform the BWP switching.

In Aspect 7, the method of Aspect 6 further includes that the downlink monitoring configuration indicates that the first BWP is associated with a first SSSG switching configuration indicating a first number of search space set groups and the second BWP is associated with a second SSSG switching configuration indicating a second number of search space set groups greater than the first number of search space set groups, wherein the DCI indicates a portion of the second number of search space set groups that corresponds up to the first number of search space set groups based on the second number of search space set groups being greater than the first number of search space set groups.

In Aspect 8, the method of Aspect 6 further includes that the downlink monitoring configuration indicates that the first BWP is associated with a first SSSG switching configuration indicating a first number of search space set groups and the second BWP is associated with a second SSSG switching configuration indicating a second number of search space set groups smaller than the first number of search space set groups, wherein the DCI indicates each of the second number of search space set groups based on the second number of search space set groups being smaller than the first number of search space set groups.

In Aspect 9, the method of Aspect 6 further includes that the downlink monitoring configuration indicates that the first BWP is associated with a PDCCH skipping configuration and the second BWP is associated with the SSSG switching configuration, wherein the DCI comprises information indicative of whether to perform physical downlink control channel (PDCCH) skipping that is interpreted as the information indicative of whether to perform the SSSG switching.

In Aspect 10, the method of any of Aspects 1-9 further includes that the switching from the first BWP to the second BWP is based on downlink control information (DCI), wherein the first BWP is configured with two SSSGs respectively associated with a first SSSG index value and a second SSSG index value, wherein the second BWP is configured with three SSSGs respectively associated with the first SSSG index value, the second SSSG index value, and a third SSSG index value, and wherein the DCI includes only one of the first SSSG index value or the second SSSG index value.

In Aspect 11, the method of Aspect 10 further includes that the first SSSG corresponds to the first SSSG index value or the second SSSG index value.

In Aspect 12, the method of any of Aspects 1-11 further includes that the switching from the first BWP to the second BWP is based on downlink control information (DCI), wherein the second BWP is configured with two SSSGs respectively associated with a first SSSG index value and a second SSSG index value, wherein the first BWP is configured with three SSSGs respectively associated with the first SSSG index value, the second SSSG index value, and a third SSSG index value, and wherein the DCI includes only one of the first SSSG index value or the second SSSG index.

In Aspect 13, the method of Aspect 12 further includes that the first SSSG corresponds to the first SSSG index value or the second SSSG index value.

In Aspect 14, the method of any of Aspects 1-13 further includes that the switching from the first BWP to the second BWP is based on downlink control information (DCI), wherein the DCI includes a first field including information and a second field including information, wherein the first BWP is configured with physical downlink control channel (PDCCH) skipping and the first BWP is configured with SSSG switching, and wherein the method further comprises interpreting the first field as the second field.

In Aspect 15, the method of Aspect 14 further includes that the first field includes a PDCCH skipping indicator field and the second field includes an SSSG indicator field.

In Aspect 16, the method of any of Aspects 1-15 further includes that the first SSSG corresponds to a previous SSSG index that the UE monitored in the second BWP in a previous downlink monitoring occasion.

In Aspect 17, the method of any of Aspects 1-16 further includes that the first SSSG corresponds to a previous SSSG index that the UE monitored in the first BWP in a previous downlink monitoring occasion.

In Aspect 18, the method of any of Aspects 1-17 further includes that the first SSSG corresponds to a previous SSSG index that the UE monitored in the first BWP in a previous downlink monitoring occasion based on each of the first BWP and the second BWP being associated with information indicative of performing SSSG switching respectively in the first BWP and the second BWP.

In Aspect 19, the method of any of Aspects 1-18 further includes that an SSSG timer and a BWP inactivity timer independently operate.

In Aspect 20, the method of any of Aspects 1-19 further includes that an SSSG timer is dependent on a BWP inactivity timer.

In Aspect 21, the method of Aspect 20 further includes suspending or terminating the SSSG timer after switching from the first BWP to the second BWP.

In Aspect 22, the method of Aspect 21 further includes switching from the second BWP to the first BWP; and starting the suspended or terminated SSSG timer after switching from the second BWP to the first BWP.

In Aspect 23, the method of any of Aspects 1-22 further includes receiving, from a base station, a downlink control information (DCI) that includes an incomplete SSSG indication or excludes an SSSG indication; and implicitly determining from the incomplete SSSG indication or the excluded SSSG indication to monitor the first SSSG in the second BWP based on the downlink monitoring configuration.

In Aspect 24, the method of Aspect 23 further includes that the switching from the first BWP to the second BWP is based on information indicative of whether to perform BWP switching.

In Aspect 25, the method of Aspect 24 further includes that the information indicative of whether to perform BWP switching comprises a first DCI without information indicative of the SSSG; a second DCI with incomplete information indicative of the SSSG; radio resource control (RRC) configuration information; expiration of a BWP inactivity timer; or expiration of an SSSG timer.

Aspect 26 is a device including one or more processors and one or more memories in electronic communication with the one or more processors storing instructions executable by the one or more processors to cause the device to implement a method as in any of Aspects 1-25.

Aspect 27 is a system or apparatus including means for implementing a method or realizing an apparatus as in any of Aspects 1-25.

Aspect 28 is a non-transitory computer readable medium storing instructions executable by one or more processors to cause the one or more processors to implement a method as in any of Aspects 1-25.

Aspect 29 is an apparatus including a memory and at least one processor coupled to the memory, where the at least one processor is configured to perform a method in any of Aspects 1-25.

Aspect 30 is a non-transitory computer-readable medium having code stored thereon that, when executed by an apparatus, causes the apparatus to perform a method in any of Aspects 1-25.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A network node for wireless communication, comprising:
a memory; and
at least one processor coupled to the memory, wherein the at least one processor is configured to:
switch from a first bandwidth part (BWP) to a second BWP; and
monitor a first search space set group (SSSG) in the second BWP during a scheduled monitoring occasion based on a downlink monitoring configuration.

2. The network node of claim 1, wherein the first SSSG corresponds to a default SSSG based on the downlink monitoring configuration excluding information indicative of the first SSSG.

3. The network node of claim 1, wherein to monitor the first SSSG, the at least one processor is configured to monitor the first SSSG before receiving or without receiving an SSSG indication indicative of the first SSSG, and wherein the first SSSG corresponds to a default SSSG.

4. The network node of claim 1, wherein to monitor the first SSSG, the at least one processor is configured to monitor a downlink channel in the second BWP according to the first SSSG based on the at least one processor being configured to switch from the first BWP to the second BWP before receiving or without receiving an SSSG indication associated with the second BWP.

5. The network node of claim 1, wherein the downlink monitoring configuration indicates one SSSG of a plurality of SSSGs configured for the second BWP as the first SSSG.

6. The network node of claim 5, wherein the at least one processor is configured to switch to the second BWP based on information indicative of whether to perform SSSG switching in the second BWP, wherein the downlink monitoring configuration includes a SSSG switching configuration for the plurality of SSSGs in the second BWP when the information is indicative of performing the SSSG switching, wherein the information indicative of whether to perform the SSSG switching is interpreted according to the SSSG switching configuration associated with the second BWP based on the at least one processor being configured to switch from the first BWP to the second BWP based on a downlink control information (DCI) that is indicative of whether to perform BWP switching, wherein the information indicative of whether to perform the SSSG switching is included in a same DCI message as the information indicative of whether to perform the BWP switching.

7. The network node of claim 6, wherein the downlink monitoring configuration indicates that the first BWP is associated with a first SSSG switching configuration indicating a first number of search space set groups and the second BWP is associated with a second SSSG switching configuration indicating a second number of search space set groups greater than the first number of search space set groups, wherein the DCI indicates a portion of the second number of search space set groups that corresponds up to the first number of search space set groups based on the second number of search space set groups being greater than the first number of search space set groups.

8. The network node of claim 6, wherein the downlink monitoring configuration indicates that the first BWP is associated with a first SSSG switching configuration indicating a first number of search space set groups and the second BWP is associated with a second SSSG switching configuration indicating a second number of search space set groups smaller than the first number of search space set groups, wherein the DCI indicates each of the second number of search space set groups based on the second number of search space set groups being smaller than the first number of search space set groups.

9. The network node of claim 6, wherein the downlink monitoring configuration indicates that the first BWP is associated with a PDCCH skipping configuration and the second BWP is associated with the SSSG switching configuration, wherein the DCI comprises information indicative of whether to perform physical downlink control channel (PDCCH) skipping that is interpreted as the information indicative of whether to perform the SSSG switching.

10. The network node of claim 1, wherein to switch from the first BWP to the second BWP, the at least one processor is configured to switch from the first BWP to the second BWP based on downlink control information (DCI), wherein the first BWP is configured with two SSSGs respectively associated with a first SSSG index value and a second SSSG index value, wherein the second BWP is configured with three SSSGs respectively associated with the first SSSG index value, the second SSSG index value, and a third SSSG index value, and wherein the DCI includes only one of the first SSSG index value or the second SSSG index value.

11. The network node of claim 10, wherein the first SSSG corresponds to the first SSSG index value or the second SSSG index value.

12. The network node of claim 1, wherein switching from the first BWP to the second BWP is based on downlink control information (DCI), wherein the second BWP is configured with two SSSGs respectively associated with a first SSSG index value and a second SSSG index value, wherein the first BWP is configured with three SSSGs respectively associated with the first SSSG index value, the second SSSG index value, and a third SSSG index value, and wherein the DCI includes only one of the first SSSG index value or the second SSSG index value.

13. The network node of claim 12, wherein the first SSSG corresponds to the first SSSG index value or the second SSSG index value.

14. The network node of claim 1, wherein to switch from the first BWP to the second BWP, the at least one processor is configured to switch from the first BWP to the second BWP based on downlink control information (DCI), wherein the DCI includes a first field including first information and a second field including second information, wherein the first BWP is configured with physical downlink control channel (PDCCH) skipping and the first BWP is configured with SSSG switching, and wherein the at least one processor is configured to:
interpret the first field as the second field.

15. The network node of claim 14, wherein the first field includes a PDCCH skipping indicator field and the second field includes an SSSG indicator field.

16. The network node of claim 1, wherein the first SSSG corresponds to a previous SSSG index that the network node monitored in the second BWP in a previous downlink monitoring occasion.

17. The network node of claim 1, wherein the first SSSG corresponds to a previous SSSG index that the network node monitored in the first BWP in a previous downlink monitoring occasion.

18. The network node of claim 1, wherein the first SSSG corresponds to a previous SSSG index that the network node monitored in the first BWP in a previous downlink monitoring occasion based on each of the first BWP and the second BWP being associated with information indicative of performing SSSG switching respectively in the first BWP and the second BWP.

19. The network node of claim 1, wherein an SSSG timer and a BWP inactivity timer independently operate.

20. The network node of claim 1, wherein an SSSG timer is dependent on a BWP inactivity timer.

21. The network node of claim 20, wherein the at least one processor is configured to:
suspend or terminate the SSSG timer after switching from the first BWP to the second BWP.

22. The network node of claim 21, wherein the at least one processor is configured to:
switch from the second BWP to the first BWP; and
start the suspended or terminated SSSG timer after switching from the second BWP to the first BWP.

23. The network node of claim 1, wherein to switch from the first BWP to the second BWP, the at least one processor is configured to switch from the first BWP to the second BWP based on information indicative of whether to perform BWP switching.

24. The network node of claim 23, wherein the information indicative of whether to perform BWP switching comprises:
first downlink control information (DCI) without information indicative of the SSSG;
second DCI with incomplete information indicative of the SSSG;
radio resource control (RRC) configuration information;
expiration of a BWP inactivity timer; or
expiration of an SSSG timer.

25. The network node of claim 23, wherein the information indicative of whether to perform BWP switching comprises expiration of a BWP inactivity timer.

26. The network node of claim 16, wherein the at least one processor is configured to:
receive downlink control information (DCI) that includes an incomplete SSSG indication or excludes an SSSG indication; and
determine, based on the incomplete SSSG indication or the excluded SSSG indication, to monitor the first SSSG in the second BWP based on the downlink monitoring configuration.

27. The network node of claim 1, wherein the first SSSG is associated with an SSSG timer and the first BWP or the second BWP is associated with a BWP inactivity timer.

28. A method of wireless communication performed by a user equipment (UE), comprising:
switching from a first bandwidth part (BWP) to a second BWP; and
monitoring a first search space set group (SSSG) in the second BWP during a scheduled monitoring occasion based on a downlink monitoring configuration.

29. An apparatus for wireless communication, comprising:
means for switching from a first bandwidth part (BWP) to a second BWP; and
means for monitoring a first search space set group (SSSG) in the second BWP during a scheduled monitoring occasion based on a downlink monitoring configuration.

30. A non-transitory computer-readable medium having code stored thereon that, when executed by an apparatus, causes the apparatus to:
switch from a first bandwidth part (BWP) to a second BWP; and
monitor a first search space set group (SSSG) in the second BWP during a scheduled monitoring occasion based on a downlink monitoring configuration.
